(19) United States
(12) Patent Application Publication
(10) Pub. No.: US 2024/0170687 A1
(43) Pub. Date: May 23, 2024

(54) CATALYST FOR FUEL CELLS AND A METHOD OF MANUFACTURING THE SAME

(71) Applicants: HYUNDAI MOTOR COMPANY, Seoul (KR); KIA CORPORATION, Seoul (KR); HEESUNG CATALYSTS CORPORATION, Siheung-si (KR)

(72) Inventors: Woo Yeong Noh, Seoul (KR); Seongmin Yuk, Yongin-si (KR); Dong Hwan Yoon, Yongin-si (KR); Woong Hee Lee, Siheung-si (KR); Sang Yun Han, Siheung-si (KR); Young San Yoo, Incheon (KR)

(73) Assignees: HYUNDAI MOTOR COMPANY, Seoul (KR); KIA CORPORATION, Seoul (KR); HEESUNG CATALYSTS CORPORATION, Siheung-si (KR)

(21) Appl. No.: 18/211,078

(22) Filed: Jun. 16, 2023

(30) Foreign Application Priority Data
Nov. 18, 2022 (KR) 10-2022-0155373

(51) Int. Cl. H01M 4/92; H01M 4/86; H01M 4/88; H01M 4/90

(52) U.S. Cl. CPC H01M 4/921; H01M 4/8657; H01M 4/8817; H01M 4/8882; H01M 4/9016

(57) ABSTRACT

A catalyst for fuel cells and a method of manufacturing the catalyst are disclosed. The catalyst forms shells in a dense structure so as to prevent elution of a transition metal and increases dispersibility through hydrophilization of the surface of the catalyst so as to be uniformly dispersed when an ink for forming a fuel cell electrode is manufactured. The catalyst may thus increase the performance and durability of a fuel cell.

### CROSS-REFERENCE TO RELATED APPLICATION

This application claims under 35 U.S.C. § 119(a) the benefit of priority to Korean Patent Application No. 10-2022-0155373 filed on Nov. 18, 2022, the entire contents of which are incorporated herein by reference.

### BACKGROUND

### (A) Technical Field

The present disclosure relates to a catalyst for fuel cells and a method of manufacturing the same.

### (b) Background Art

A polymer electrolyte membrane fuel cell (PEMFC) electrochemically generates water using hydrogen as fuel supplied to an anode and using air as fuel supplied to a cathode. Electrons migrate from the anode to the cathode through electrical charges. Oxygen reacts with the electrons and protons, generated from hydrogen, at the cathode, and is thus reduced to generate water. The overall chemical potential difference is 1.23 V under standard conditions, as described in the Equations below, and it serves as the voltage of a single cell.

Anode: H₂→2H⁺+2e⁻,Eₒ=0.00 V

Cathode: 1/2O₂+2H⁺+2e⁻→H₂O,Eₒ=1.23 V

Total: H₂+1/2O₂→H₂O,Eₒ=1.23 V

At present, a platinum catalyst is mainly used as an electrode catalyst in PEMFCs. Platinum is relatively stable even at a relatively high potential in an acidic state and has excellent activity against hydrogen and oxygen and excellent durability. However, platinum is expensive so that the price of 1 g of platinum may be in the range of US$20-25. Thus, in order to commercialize PEMFCs, research on a platinum-transition metal alloy catalyst or a core-shell catalyst is ongoing in order to reduce the amount of platinum consumed while increasing the amount of a transition metal consumed.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. It is an object of the present disclosure to provide a catalyst for fuel cells in which a shell is formed in a dense structure so as to prevent elution of a transition metal. The catalyst also increases dispersibility through hydrophilization of the surface of the catalyst so as to be uniformly dispersed when an ink for forming a fuel cell electrode is manufactured. The catalyst may thus increase the performance and durability of a fuel cell.

In one aspect, the present disclosure provides a catalyst for fuel cells including core-shell particles having a core including an alloy of a precious metal and a transition metal, and having a shell located on the core and including the precious metal. The catalyst also includes a carbon-based support configured to support the core-shell particles. A surface of the catalyst includes a hydrophilic group.

In an embodiment, the precious metal may include at least one selected from the group consisting of, or may comprise, platinum (Pt), ruthenium (Ru), osmium (Os), iridium (Ir), palladium (Pd), or any combination thereof.

In another embodiment, the transition metal may include at least one selected from the group consisting of, or may comprise, cobalt (Co), iron (Fe), nickel (Ni), zinc (Zn), tin (Sn), manganese (Mn), copper (Cu), scandium (Sc), titanium (Ti), vanadium (V), chrome (Cr), zirconium (Zr), yttrium (Y), niobium (Nb), or any combination thereof.

In still another embodiment, a molar ratio (P/M) of the precious metal (P) to the transition metal (M) of the core may be in a range of 1 to 3.

In yet another embodiment, a molar ratio (P/M) of the precious metal (P) to the transition metal (M) of the shell may be in a range of 3 to 10.

In still yet another embodiment, the shell may have a thickness in a range of 0.5 nm to 1 nm.

In a further embodiment, the core-shell particles may have a particle size in a range of 2 nm to 20 nm.

In another further embodiment, the hydrophilic group may include at least one selected from the group consisting of, or may comprise, a hydroxyl group, a carbonyl group, a carboxyl group, or any combination thereof.

In still another further embodiment, a weight ratio (O/H) of oxygen atoms (O) to hydrogen atoms (H) on the surface of the catalyst may be in a range of 15 to 35. In yet another further embodiment, an elution amount of the precious metal or

the transition metal when the catalyst is immersed in a 1 mole per liter or mol/L (M) perchloric acid (HClO₄) solution at a temperature of 80° C. for 24 hours may be in a range of 0.1 parts per million (ppm) to 15 ppm per gram of the catalyst.

In still yet another further embodiment, the catalyst may include an amount of 30 wt. % to 70 wt. % of the carbon-based support and may include an amount of 30 wt. % to 70 wt. % of the core-shell particles based on a total weight of the catalyst.

In another aspect, the present disclosure provides a method of manufacturing a catalyst for fuel cells. The method includes supporting a precious metal and a transition metal on a carbon-based support. The method also includes primarily annealing an acquired resultant product so as to form alloyed cores. The method further includes primarily surface-treating the alloyed cores with an acid solution so as to form shells. The method also includes secondarily annealing the catalyst acquired by primarily surface-treating the alloyed cores and secondarily surface-treating the secondarily annealed catalyst with an acid solution so as to hydrophilize a surface of the catalyst.

In an embodiment, primarily annealing the acquired resultant product may be performed at a temperature in a range of 700° C. to 1,100° C. for about 10 minutes to 4 hours.

In another embodiment, the acid solutions may include at least one selected from the group consisting of, or may comprise, nitric acid, sulfuric acid, acetic acid, phosphorous acid, potassium permanganate, hydrogen peroxide, hydrochloric acid, chloric acid, hypochlorous acid, chromic acid, or any combination thereof.

In still another embodiment, concentrations of the acid solutions may be in a range of 0.01 mol/L to 0.5 mol/L.

In yet another embodiment, secondarily annealing the catalyst may be performed at a temperature in a range of 300° C. to 600° C. for 2 hours to 6 hours.

In still yet another embodiment, secondarily surface-treating the secondarily annealed catalyst may be performed at a temperature in a range of 70° C. to 100° C. for 10 minutes to 2 hours.

Other aspects and embodiments of the present disclosure are discussed hereinbelow.

The above and other features of the present disclosure are discussed hereinbelow as well.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a flowchart schematically showing a method of manufacturing a catalyst for fuel cells according to the present disclosure.

It should be understood that the appended drawings are not necessarily drawn to scale, presenting a somewhat simplified representation of various features illustrative of the basic principles of the present disclosure. The specific design features as disclosed herein, including, for example, specific dimensions, orientations, locations, and shapes, will be determined in part by the particular intended application and use environment.

In the FIGURES, the same reference numbers refer to the same or equivalent parts of the present disclosure throughout the several FIGURES of the drawing.

### DETAILED DESCRIPTION

The above-described objects, other objects, advantages, and features of the present disclosure should be more apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those of ordinary skill in the art.

In the following description of the embodiments, the same elements are denoted by the same reference numerals even when they are depicted in different drawings. In the drawings, the dimensions of structures may be exaggerated compared to the actual dimensions thereof for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the present disclosure. Singular expressions may encompass plural expressions, unless they have clearly different contextual meanings.

In the following description of the embodiments, terms, such as “including”, “comprising”, and “having”, and variations thereof, should be interpreted as indicating the presence of characteristics, numbers, steps, operations, elements, or parts stated in the description or combinations thereof. Such terms do not exclude the presence of one or more other characteristics, numbers, steps, operations, elements, parts, or combinations thereof, or the possibility of adding the same. In addition, it should be understood that, when a part, such as a layer, a film, a region, or a plate, is said to be “on” another part, the part may be located “directly on” the other part or other parts may be interposed between the two parts. In the same manner, it should be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are acquired from essentially different things are reflected and thus it should be understood that they are modified by the term “about”, unless stated otherwise. In addition, it should be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. Further, with respect to such ranges, it should be understood that the above-mentioned modifier “about” and the measurement uncertainties and approximations are equally applicable.

A catalyst for fuel cells according to the present disclosure may include core-shell particles, each including a core and a shell, and a carbon-based support configured to support the core-shell particles.

The cores may include an alloy of a precious metal and a transition metal.

The precious metal may include at least one selected from the group consisting of, or may comprise, platinum (Pt), ruthenium (Ru), osmium (Os), iridium (Ir), palladium (Pd), or any combination thereof.

The transition metal may include at least one selected from the group consisting of, or may comprise, cobalt (Co), iron (Fe), nickel (Ni), zinc (Zn), tin (Sn), manganese (Mn), copper (Cu), scandium (Sc), titanium (Ti), vanadium (V), chrome (Cr), zirconium (Zr), yttrium (Y), niobium (Nb), or any combination thereof.

The molar ratio (P/M) of the precious metal (P) to the transition metal (M) of the cores may be in a range of 1 to 3. Here, when the molar ratio (P/M) of the precious metal (P) to the transition metal (M) of the cores is less than 1, the ratio of the precious metal is low and thus activity of the catalyst may be reduced. Further, although the upper limit of the molar ratio (P/M) of the precious metal (P) to the transition metal (M) of the cores is not limited, in order to firmly achieve the activity improvement effect due to the transition metal, the molar ratio (P/M) of the precious metal (P) to the transition metal (M) of the cores may be equal to or less than 3. This is in consideration of a cost increase due to the increase in the amount of the precious metal supported.

The molar ratio (P/M) of the precious metal (P) to the transition metal (M) may be measured by an analysis method of directly measuring the contents of the respective metals in the catalyst using inductively coupled plasma (ICP). The molar ratio (P/M) may alternatively be measured by a component analysis method using an electron beam or X-ray spectrum analyzer, such as an electron probe microanalyzer (EPMA) or an energy dispersive X-ray spectroscopy (EDX). In terms of accuracy, the direct analysis method using ICP may be advantageous.

When the cores are surface-treated in order to manufacture the core-shell particles by increasing the ratio of the precious metal on the surfaces of the cores, as described below, gaps are formed in the surface of the catalyst. Thus, the precious metal or the transition metal in the particles of the catalyst may be eluted at the time of fuel cell reaction. The performance and durability of a fuel cell may thereby be deteriorated due to damage to a polymer electrolyte membrane. In order to solve such a problem, the transition metal is removed from the surfaces of the cores, and then the gaps present in the surface of the catalyst are removed through additional annealing.

Therefore, the catalyst may include the shells located on the cores and may include a large amount of the precious metal present on the surfaces of the shells at a high density. Here, the shells are formed by surface-treating the cores with acid solutions. Thus, the precious metal of the shells may be the same element as the precious metal included in the cores.

The shells have a high molar ratio (P/M) of the precious metal (P) to the transition metal (M) because the shells include a large amount of the precious metal and have low porosity because the gaps are removed from the shells.

For example, the molar ratio (P/M) of the precious metal (P) to the transition metal (M) of the shells may be equal to or less than 10, and, for example, may be in a range of 1 to 10, or may be 3 to 10. The molar ratio (P/M) of the precious metal (P) to the transition metal (M) of the shells may be measured by the analysis method of directly measuring the contents of the respective metals in the catalyst using inductively coupled plasma (ICP) or may be measured by the component analysis method using an electron beam or X-ray spectrum analyzer, such as an electron probe microanalyzer (EPMA) or an energy dispersive X-ray spectroscopy (EDX). Here, when the molar ratio (P/M) of the precious metal (P) to the transition metal (M) of the shells exceeds 10, the amount of the transition metal is greatly reduced. Thus, the effects of addition of the transition metal may be lost.

The thickness of the shells may be equal to or less than 1 nm, and in an example may be in a range of 0.5 nm to 1 nm. When the thickness of the shells is less than 0.5 nm, the shells are too thin. Thus, the precious metal or the transition metal in the particles of the catalyst may be eluted at the time of the fuel cell reaction. Further, when the thickness of the shells exceeds 1 nm, the catalyst has a similar surface structure to a precious metal catalyst rather than an alloy catalyst and may lose performance improvement effects caused by alloying.

The particle size of the core-shell particles may be in a range of 2 nm to 20 nm. When the particle size of the core-shell particles is less than 2 nm, regularity of atomic arrangement may be insufficient and long-term activity persistence characteristics may not be firmly acquired. Further, when the particle size of the core-shell particles exceeds 20 nm, it may be difficult to electrochemically secure the specific surface area of the catalyst and to sufficiently acquire the initial activity of the catalyst.

In the present disclosure, the particle size of the core-shell particles indicates the particle sizes of only the core-shell particles including the core and shell, i.e., the size of crystals, which are connected (referred to as a crystallite diameter), and does not include the particle size of the carbon-based support. The particle size of the core-shell particles may be calculated by the Scherrer equation from the full width at half maximum (FWHM) of an XRD peak.

The core-shell particles may be supported on the carbon-base support.

The carbon-based support may include at least one selected from the group consisting of, or may comprise, carbon black, graphite, carbon nanofiber, graphitized carbon nanofiber, carbon nanotubes, carbon nanohorns, carbon nanowires, graphene, or any combination thereof.

The carbon black may include, for example, at least one selected from the group consisting of, or may comprise, Denka black, Ketjen black, acetylene black, channel black, furnace black, lamp black, thermal black, or any combination thereof.

The specific surface area of the carbon-based support may be in a range of 250 m²/g to 1,200 m²/g. When the specific surface area of the carbon-based support is equal to or greater than 250 m²/g, an area to which the core-shell particles are attached may be increased and may thus highly disperse the core-shell particles and increase an effective surface area. On the other hand, when the specific surface area of the carbon-based support exceeds 1,200 m²/g, the ratio of ultra-fine holes having a size of less than about 20 angstroms), into which an ion exchange resin has difficulty penetrating, is increased when an electrode for fuel cells is formed. Thus, utilization efficiency of the catalyst may be reduced.

When annealing is performed to compact the surfaces of the particles of the catalyst, from which the transition metal is removed, after the transition metal has been removed from the surfaces of the cores, so as to manufacture the core-shell particles, the surfaces of the particles of the catalyst are extremely hydrophobized. Thus, it may be difficult to uniformly disperse the catalyst when an ink for forming a fuel cell electrode is manufactured. The performance and durability of the catalyst may thereby be reduced.

In order to solve such a problem, the surface of the catalyst may be hydrophilized within a proper range by adjusting the number of oxygen atoms (O)) and the number of hydrogen atoms (H). For example, the surface of the catalyst may further include a hydrophilic functional group through additional surface treatment after annealing. The hydrophilic functional group may include, for example, at least one selected from the group consisting of, or may comprise, a hydroxyl group, a carbonyl group, a carboxyl group, or any combination thereof.

Thereby, the weight ratio (O/H) of oxygen atoms (O)) to hydrogen atoms (H) on the surface of the catalyst measured by elemental analysis may be equal to or less than 35 and, for example, may be in a range of 15 to 35, or may be in a range of 20 to 30. Here, the weight ratio (O/H) of oxygen atoms (O)) to hydrogen atoms (H) may be measured by an analysis method of directly measuring the contents of the respective elements of the catalyst using an elemental analyzer. Alternatively, the weight ratio (O/H) may be measured by the component analysis method using an electron beam or X-ray spectrum analyzer, such as an electron probe microanalyzer (EPMA) or an energy dispersive X-ray spectroscopy (EDX).

When the weight ratio (O/H) of oxygen atoms (O)) to hydrogen atoms (H) is less than 15, non-uniformity of the ink for forming a fuel cell electrode is increased, and thus, the performance and durability of the fuel cell may be reduced. Further, when the weight ratio (O/H) of oxygen atoms (O)) to hydrogen atoms (H) exceeds 35, water generated by the fuel cell electrode reaction is not smoothly discharged due to introduction of an excessive amount of the hydrophilic functional group. Thus, the performance and durability of the fuel cell may be reduced and the amount of water present around the catalyst is increased and may thus increase corrosion of carbon used as the support.

When the catalyst is immersed in a 1 mole per liter or mol/L (M) perchloric acid (HClO₄) solution at a temperature of 80° C. for 24 hours, the elution amount of the precious metal or the transition metal may be in a range of 0.1 ppm to 15 ppm per gram of the catalyst. The elution amount may be measured by ICP analysis. When the elution amount of the precious metal or the transition metal in the catalyst exceeds 15 parts per million (ppm) per gram of the catalyst, the precious metal or the transition metal in the catalyst particles is eluted at the time of the fuel cell reaction and thus damages the polymer electrolyte membrane. The performance and durability of the fuel cell may thereby be reduced.

The contents of the carbon-based support and the core-shell particles with respect to the total weight of the catalyst may be properly adjusted in consideration of the performance of the catalyst as an electrode of the fuel cell. For example, the catalyst according to the present disclosure may include an amount in a range of 30 wt. % to 70 wt. % of the carbon-based support and an amount in a range of 30 wt. % to 70 wt. % of the core-shell particles with respect to the total weight of the catalyst, without being limited thereto. When the content of the core-shell particles is less than 30 wt. %, the processability, performance, and durability of the fuel cell may be reduced due to increase in the thickness of the electrode. Further, when the content of the core-shell particles exceeds 70 wt. %, particle agglomeration is accelerated at the time of annealing at a high temperature and may thus reduce the performance and durability of the fuel cell.

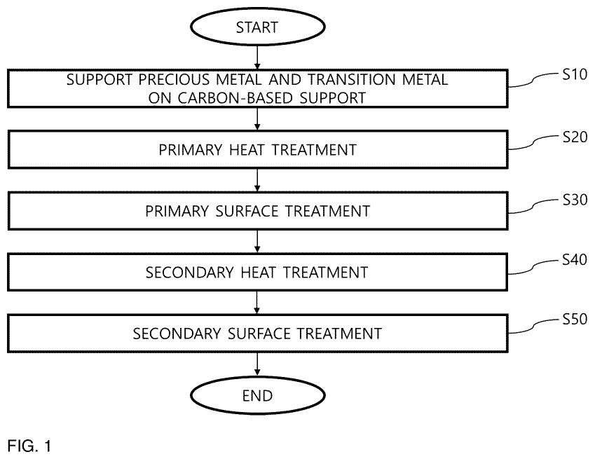

FIG. 1 is a flowchart schematically illustrating a method of manufacturing a catalyst for fuel cells according to the present disclosure. Referring to FIG. 1, the method may include supporting a precious metal and a transition metal on a carbon-based support by immersing the carbon-based support in a solution including a precious metal precursor, and in a solution including a transition metal precursor (operation S10). The method may also include forming alloyed cores by performing a primary heat treatment on the resultant product (operation S20) and forming shells by performing a primary surface treatment to the alloyed cores with an acid solution (operation S30). The method may also include performing a secondary heat treatment to the catalyst on which the primary surface treatment was performed (operation S40). The method may also include hydrophilizing a surface of the catalyst by performing a secondary surface treatment to the catalyst on which the secondary heat treatment was performed (operation S50).

First, the precious metal and the transition metal are supported on the carbon-based support by immersing the carbon-based support in the solution including the precious metal precursor and the transition metal precursor (operation S10).

In operation S10, the precious metal particles may be first supported on the carbon-based support. Thereafter, transition metal particles may be supported on the carbon-based support.

In the present disclosure, support of the precious metal particles on carbon-based support is not limited to a specific method and may employ, for example, a chemical reduction method. In other words, the precious metal particles may be precipitated and supported on the carbon-based support by adding a reducing agent while mixing the solution including the precious metal precursor and the carbon-based support, and by refluxing a mixed solution.

The precious metal precursor may be provided in the form of a precious metal salt and may include at least one selected from the group consisting of, or may comprise, nitrates, sulphates, acetates, chlorides, oxides, or any combination thereof. For example, when the precious metal is platinum, a platinum precursor may be diamminebis(nitrito-N)platinum, chloroplatinic acid, or potassium hexachloroplatinate, and more concretely, may be a basic platinum precursor, such as (MEA)₂Pt(OH)₆, [Pt(NH₃)₄]Cl₂, [Pt(NH₃)₄](NO₃)₂, [Pt(NH₃)₄](OH)₂, Pt(NH₃)₂Cl₂, or (NH₄)₂[PtCl₄].

In order to precipitate the precious metal particles on the carbon-based support, the solution including the precious metal precursor and the carbon-based support may be mixed. Thereafter, the reducing agent may be added to the mixed solution. The reducing agent may be an alcohol-based reducing agent and, for example, may be methanol, ethanol, or ethylene glycol (EG).

As the refluxing (reducing) conditions after addition of the reducing agent, the temperature of the mixed solution may be set to be equal to or higher than about 60° C. but to be equal to or lower than the boiling point. The reduction time of the mixed solution may be set to a range of 3 hours to 6 hours.

When the transition metal particles are supported on the carbon-based support on which the precious metal particles are supported, support of the transition metal particles on the carbon-based support may also employ the chemical reduction method in the same manner as support of the precious metal particles on the carbon-based support.

More concretely, the transition metal particles may be precipitated near the precious metal particles on the carbon-based support by immersing the carbon-based support, on which the precious metal particles are supported, in the solution including the transition metal and then reducing the solution.

The transition metal precursor may be provided in the form of a transition metal salt and may include at least one selected from the group consisting of, or may comprise, nitrates, sulphates, acetates, chlorides, oxides, or any combination thereof. Also, for example, the transition metal precursor may be a transition metal acetylacetonate, a transition metal hexafluoroacetylacetonate, or a transition metal pentafluoroacetylacetonate. Further, when the transition metal is nickel, the transition metal precursor may employ nickel(II) chloride hexahydrate, nickel nitrate, or nickel(II) acetate tetrahydrate.

In supporting the transition metal particles on the carbon-based support, the amount of the transition metal supported may be adjusted by the concentration and amount of the precursor solution. Since the molar ratio (P/M) of the precious metal (P) to the transition metal (M) of the cores may be equal to or greater than 1, as described above, the amount of the transition metal supported may be adjusted so as to set the molar ratio (P/M) of the precious metal (P) to the transition metal (M) of the cores within the above-described range. However, when the primary surface treatment of the cores is performed with the acid solution in operation S30, which is described below, the transition metal is partially eluted. Therefore, the amount of the transition metal supported in operation S10 may be adjusted to be slightly greater than an amount to satisfy the set molar ratio (P/M), for example, by 0.4 times or 2 times.

Thereafter, the resultant product may perform a primarily heat treatment so as to form the alloyed core (operation S20).

In operation S20, the catalyst on which the precious metal and the transition metal are supported on the carbon-based support may be dried before the primary heat treatment.

Operation S20 may be performed at a temperature in a range of 700° C. to 1,100° C. When the primary heat treatment temperature is lower than 700° C., formation of an alloy phase between the precious metal and the transition metal is insufficient, and thus, the catalyst may lack activity. Further, since, as the heat treatment (annealing) temperature increases, alloying is performed but the size of the particles of the catalyst is excessively increased. When the primary heat treatment temperature exceeds 1,000° C., it may be difficult to apply the catalyst to equipment.

Operation S20 may be performed within a range of 10 minutes to 4 hours. When the primary heat treatment time is less than 10 minutes, alloying of the cores may not be smoothly performed. Further, when the primary heat treatment time exceeds 4 hours, the particle size of the catalyst is excessively increased and may thus negatively affect the operation of the fuel cell.

Operation S20 may be performed in a non-acidic atmosphere, and for example, in a reducing atmosphere (in a hydrogen gas atmosphere or the like).

Thereafter, the cores may be subject to the primarily surface treatment with the acid solution so as to form the shells (operation S30).

More concretely, in operation S30, the shells are formed by surface treatment of the alloyed cores with the acid solution. In other words, the transition metal is partially eluted on the surfaces of core particles by performing the surface treatment of the alloyed cores with the acid solution. Thereby, the shells are formed, and the activity and durability of the catalyst may be improved due to reduction in the concentration of the transition metal on the surfaces of the catalyst particles.

In operation S30, the acid solution may include at least one selected from the group consisting of, or may comprise, nitric acid, sulfuric acid, acetic acid, phosphorous acid, potassium permanganate, hydrogen peroxide, hydrochloric acid, chloric acid, hypochlorous acid, chromic acid, or any combination thereof.

In operation S30, the concentration of the acid solution may be in a range of 0.01 mol/L to 0.5 mol/L, and more particularly, may be in a range of 0.1 mol/L to 0.5 mol/L. The primary surface treatment may be performed by immersing the alloyed cores in the acid solution.

In operation S30, the contact time of the alloyed cores with the acid solution may be within a range of 1 hour to 30 hours, and for example, may be within a range of 2 hours to 12 hours. Further, the treatment temperature of the alloyed cores with the acid solution may be in a range of 40° C. to 100° C., and for example, may be in a range of 60° C. to 90° C.

Further, the primary surface treatment in which the alloyed cores come into contact with the acid solution may be performed once or may be repeated multiple times. Further, when the primary surface treatment is repeated multiple times, the kind of the acid solution used may be changed.

Thereafter, the catalyst including the cores and the shells that have been subject to the primary surface treatment the core may perform the secondarily heat treatment (operation S40).

When the catalyst is surface-treated by increasing the ratio of the precious metal on the surfaces of the core particles in order to manufacture the core-shell particles, gaps are formed in the surface of the catalyst. Thus, the precious metal or the transition metal in the particles of the catalyst may be eluted at the time of fuel cell reaction. The performance and durability of a fuel cell may thereby be deteriorated due to damage to a polymer electrolyte membrane. In other words, the shell particles formed by eluting the transition metal on the surfaces of the core particles may be formed in a skeleton phase, and the precious metal or the transition metal may be eluted through these gaps.

In order to solve the above problem, the transition metal may be removed from the surfaces of the cores, the gaps present in the surface of the catalyst may be removed through the secondary heat treatment, and the ratio of the precious metal in the shells may be increased.

The secondary heat treatment for removing the gaps in the shells may be performed at a temperature of in a range of 300° C. to 600° C. When the secondary heat treatment temperature is lower than 300° C., the gaps in the shells may not be removed. Further, when the secondary heat treatment temperature exceeds 600° C., the particle size of the catalyst may be increased.

Operation S40 may be performed within a range of 2 hours to 6 hours. When the secondary heat treatment time is less 2 hours, the gaps in the shells may not be removed. Further, when the secondary heat treatment time exceeds 6 hours, the particle size of the catalyst may be increased.

Operation S40 may be performed in a non-acidic atmosphere, and for example, in a reducing atmosphere (in a hydrogen gas atmosphere or the like).

Finally, hydrophilizing a surface of the catalyst may be achieved by performing a secondary surface treatment to the catalyst that has been subjected to a secondary heat treatment.

In other words, the secondarily annealed catalyst may be subjected to the secondary surface treatment with the acid solution so as to hydrophilize the surface of the catalyst (operation S50).

When the catalyst is secondarily annealed to compact the surface of the catalyst after the transition metal has been removed from the surfaces of the alloyed core particles so as to manufacture the core-shell particles, the surfaces of the particles of the catalyst are extremely hydrophobized. Thus, it may be difficult to uniformly disperse the catalyst when an ink for forming a fuel cell electrode is manufactured. The performance and durability of the catalyst may thereby be reduced.

In order to solve the above problem, a hydrophilic group may be introduced into the surfaces of the catalyst particles by hydrophilizing the surface of the catalyst by secondarily surface-treating the secondarily annealed catalyst with the acid solution.

In operation S50, the acid solution may include at least one selected from the group consisting of, or may comprise, nitric acid, sulfuric acid, acetic acid, phosphorous acid, potassium permanganate, hydrogen peroxide, hydrochloric acid, chloric acid, hypochlorous acid, chromic acid, or any combination thereof.

In operation S50, the concentration of the acid solution may be in a range of 0.01 mol/L to 0.5 mol/L. The secondary surface treatment may be performed by immersing the secondarily annealed catalyst in the acid solution.

In operation S50, the contact time of the catalyst with the acid solution may be within a range of 10 minutes to 2 hours. Further, the treatment temperature of the catalyst with the acid solution may be in a range of 70° C. to 100° C.

Further, the secondary surface treatment, in which the secondarily heat treated catalyst comes into contact with the acid solution, may be performed once or may be repeated multiple times. Further, when the secondary surface treatment is repeated multiple times, the kind of the acid solution may be changed.

Another embodiment of the present disclosure provides an electrode for fuel cells, which includes the above-described catalyst for fuel cells and an ionomer mixed with the catalyst.

Yet another embodiment of the present disclosure provides a membrane-electrode assembly including an anode and a cathode located opposite each other and an ion exchange membrane located between the anode and the cathode, at least one of the anode, and the cathode including the above-described electrode.

A further embodiment of the present disclosure provides a fuel cell including the above-described membrane-electrode assembly.

The above-described electrode, membrane-electrode assembly, and fuel cell have the same configurations as those of general electrodes for fuel cells, general membrane-electrode assemblies for fuel cells, and general fuel cells, except that they include the above-described catalyst. A detailed description thereof will has been omitted.

Hereinafter, the technical concepts of the present disclosure are described in more detail through the following examples. The following examples serve merely to describe aspects of the present disclosure and are not intended to limit the scope of the disclosure.

### Manufacturing Example

### Example 1

Carbon black and ethylene glycol were mixed, a platinum precursor was added at a designated ratio thereto, and then, an acquired mixture was stirred. Thereafter, the mixture was heated to a temperature of 160° C. in a reactor and was then maintained at the same temperature for 5 hours. A platinum slurry in which platinum is supported on a support was acquired by removing residual impurities and unreacted matter from the mixture after reaction through filtration and washing several times.

A solution, in which Ni(NO₃)₂·6H₂O serving as a nickel precursor and distilled water were mixed in a designated ratio, was added to the platinum slurry acquired after washing and then an acquired mixture was stirred. Thereafter, a solution, in which sodium borohydride (NaBH₄) and distilled water were mixed in a designated ratio, was added to the mixture at a designated rate and then an acquired catalyst was stirred. Residual impurities and unreacted matter were removed from the catalyst after reaction through filtration and washing several times.

In order to alloy platinum and nickel with each other, the catalyst was primarily annealed at a high temperature. Primary annealing was performed at a temperature of 900° C. for 30 minutes in a reactor under a nitrogen atmosphere.

After primary annealing, the catalyst was primarily surface-treated using an acid solution. After the primarily annealed catalyst was mixed with a H₂SO₄ solution, the catalyst was primarily surface-treated at a temperature of 80° C. for 2 hours, and then filtration and washing several times were performed. In addition, after the washed catalyst was mixed with a HNO₃ solution, the catalyst was primarily surface-treated at a temperature of 70° C. for 2 hours, and then filtration and washing several times were performed. The surface treatment using the HNO₃ solution was performed two times.

The primary surface-treated catalyst was secondarily annealed so as to prevent elution of the metals in the catalyst and to further compact the surface of the catalyst, from which the transition metal was removed. Secondary annealing was performed at a temperature of 300° C. for 4 hours in a reactor under a hydrogen atmosphere.

After secondary annealing, the catalyst was secondarily surface-treated using an acid solution. After the secondarily annealed catalyst was mixed with a 0.1 M HNO₃ solution, the catalyst was secondarily surface-treated at a temperature of 90° C. for 30 minutes, and then filtration, washing several times, and drying were performed. Thereby, a catalyst having core-shell particles for fuel cells was manufactured.

### Example 2

A catalyst having core-shell particles for fuel cells was manufactured in the same manner as in Example 1, except that, after the secondarily annealed catalyst was mixed with a 0.1 M H₂SO₄ solution, the catalyst was secondarily surface-treated at a temperature of 90° C. for 30 minutes, and then filtration, washing several times, and drying were performed.

### Example 3

A catalyst having core-shell particles for fuel cells was manufactured in the same manner as in Example 1, except that, after the secondarily annealed catalyst is mixed with a 0.1 M acetic acid solution, the catalyst was secondarily surface-treated at a temperature of 90° C. for 30 minutes, and then filtration, washing several times, and drying were performed.

### Comparative Example 1

A catalyst having core-shell particles for fuel cells was manufactured in the same manner as in Example 1, except that the secondarily annealed catalyst was not secondarily surface-treated.

### Comparative Example 2

A catalyst having core-shell particles for fuel cells was manufactured in the same manner as in Example 1, except that, after the secondarily annealed catalyst was mixed with a 1 M HNO₃ solution, the catalyst was secondarily surface-treated at a temperature of 90° C. for 30 minutes, and then filtration, washing several times, and drying were performed.

### Comparative Example 3

A catalyst having core-shell particles for fuel cells was manufactured in the same manner as in Example 1, except that, after the secondarily annealed catalyst was mixed with a 2 M HNO₃ solution, the catalyst was secondarily surface-treated at a temperature of 90° C. for 30 minutes, and then filtration, washing several times, and drying were performed.

### Test Example 1: Comparison of Characteristics Among Catalysts

A test to compare characteristics among the catalysts manufactured in Examples 1, 2, and 3 and Comparative Examples 1, 2, and 3 was executed. Results of the test are set forth in Table 1 below.

### Evaluation Method

O/H ratio of Catalyst: The catalysts were dropped in a high-temperature combustion chamber using an elemental analyzer so as to be oxidized through exothermic reaction, and the contents of oxygen (O) and hydrogen (H) in the catalysts were measured by a detector.
P/M ratio of Catalyst: The contents of the precious metal (P) and the transition metal (M) in the catalysts were measured by ICP analysis, and the molar ratios of the precious metal (P) to the transition metal (M) of the respective catalysts were calculated.
Catalyst particle size: X-ray Diffraction (XRD) was performed with respect to the catalysts, and the particle sizes of the respective catalysts were calculated using (220) planes.

TABLE 1

| | | | | Comp. | Comp. | Comp. |
|---|---|---|---|---|---|---|
| | Exam- | Exam- | Exam- | Exam- | Exam- | Exam- |
| | ple 1 | ple 2 | ple 3 | ple 1 | ple 2 | ple 3 |
| O/H ratio of | 26.39 | 28.74 | 29.50 | 13.47 | 35.46 | 39.22 |
| catalyst | | | | | | |
| P/M ratio of | 3.97 | 3.94 | 3.86 | 4.18 | 3.95 | 3.89 |
| catalyst | | | | | | |
| Catalyst | 3.78 | 3.84 | 3.85 | 3.85 | 3.77 | 3.66 |
| particle | | | | | | |
| size (nm) | | | | | | |

Referring to Table 1 above, it may be confirmed that the catalyst according to Comparative Example 1, which did not undergo secondary surface treatment so that the surface of the catalyst was not hydrophilized, has a low O/H ratio. Further, it may be confirmed that the catalysts according to Comparative Examples 2 and 3, which did undergo secondary surface treatment with an acid solution having high concentrations, has high O/H ratios. It may thereby be confirmed that, as the molar concentration of an acid solution increases, the O/H ratio of an acquired catalyst increases.

When the weight ratio (O/H) of oxygen atoms (O)) to hydrogen atoms (H) on the surface of the catalyst is less than 15 as in Comparative Example 1, non-uniformity of an ink for forming a fuel cell electrode, which is manufactured using the catalyst, is increased. Thus, the performance and durability of a fuel cell may be reduced.

Further, when the O/H ratio of the catalyst exceeds 35 as in Comparative Examples 2 and 3, water generated by fuel cell electrode reaction is not smoothly discharged due to introduction of an excessive amount of a hydrophilic group. Thus, the performance and durability of a fuel cell may be reduced and the amount of water present around the catalyst is increased, which may thus increase corrosion of carbon used as a support.

Moreover, strong acid solutions were used in secondary surface treatment of the catalysts according to Examples 1 and 2 and a weak acid solution was used in secondary surface treatment of the catalyst according to Example 3. Thus, it may be confirmed that use of the strong and weak acid solutions shows no significant difference. Thereby, it may also be confirmed that the ratio of a group on the surface of a catalyst is varied depending on the concentration of an acid solution and acid treatment conditions (i.e., temperature and time).

In addition, by the results of measurement of the sizes of the catalyst particles, it may be confirmed that the size of catalyst particles is not much varied depending on an O/H ratio.

### Test Example 2: Comparison of Performance Among Fuel Cells

A test to compare the performances of fuel cells, to which the catalysts manufactured according to Examples 1, 2, and 3 and Comparative Examples 1, 2, and 3 were applied, was executed. Results of the test are set forth in Table 2 below.

The fuel cells were manufactured by the Decal method.

In order to evaluate the durability of the catalysts, a durability test was performed under conditions suggested by the United States Department of Energy (DoE). Also, the catalytic loss of each of the catalysts was acquired by calculating the catalytic activity in the first cycle and the catalytic activity in the thirty thousand^{th} cycle of the respective catalysts.

Further, in order to measure the elution amounts of the transition metal of the catalysts, supernatants, generated by distrusting the catalysts in a 1M HClO₄ solution, and then performing reaction at a temperature of 80° C. for 24 hours, were analyzed by ICP analysis.

TABLE 2

| | | | | Comp. | Comp. | Comp. |
|---|---|---|---|---|---|---|
| | Exam- | Exam- | Exam- | Exam- | Exam | Exam |
| | ple 1 | ple 2 | ple 3 | ple 1 | ple 2 | ple 3 |
| Catalytic loss | 6.4 | 8.1 | 7.8 | 7.3 | 12.1 | 13.9 |
| (%) | | | | | | |
| Elution amount | 9 | 11 | 12 | 15 | 21 | 36 |
| of transition | | | | | | |
| metal (ppm) | | | | | | |

Referring to Table 2 above, it may be confirmed that the catalysts manufactured according to Examples have improved durability compared to the catalysts manufactured according to Comparative Examples. This is the effect exhibited by the O/H ratio, which is equal to or greater than a designated value.

However, it may be confirmed that, when the O/H ratio is excessively increased as in Comparative Examples 2 and 3, the durability of the catalyst is decreased.

Therefore, the catalyst for fuel cells according to the present disclosure forms shells in a dense structure so as to prevent elution of the transition metal. The catalyst also increases dispersibility through hydrophilization of the surface of the catalyst so as to be uniformly dispersed when an ink for forming a fuel cell electrode is manufactured. The catalyst may thus increase the performance and durability of a fuel cell.

As is apparent from the above description, a catalyst for fuel cells according to the present disclosure may have a dense surface acquired by removing a transition metal from the surface of the catalyst, may employ a hydrophilic group so as to be uniformly dispersed when an ink for forming a fuel cell electrode is manufactured, and may thus increase the performance and durability of a fuel cell.

The technical concepts of the present disclosure have been described in detail with reference to embodiments thereof. However, it should be appreciated by those of ordinary skill in the art that changes may be made in these embodiments without departing from the principles and spirit of the disclosure, the scope of which is defined by the appended claims and their equivalents.

What is claimed is:

1. A catalyst for fuel cells, the catalyst comprising:
core-shell particles; and
a carbon-based support configured to support the core-shell particles,
wherein the core-shell particles include cores having an alloy of a precious metal and a transition metal and shells having the precious metal located on the cores, and
wherein a surface of the catalyst includes a hydrophilic group.

2. The catalyst of claim 1, wherein the precious metal comprises platinum (Pt), ruthenium (Ru), osmium (Os), iridium (Ir), palladium (Pd), or any combination thereof.

3. The catalyst of claim 1, wherein the transition metal comprises cobalt (Co), iron (Fe), nickel (Ni), zinc (Zn), tin (Sn), manganese (Mn), copper (Cu), scandium (Sc), titanium (Ti), vanadium (V), chrome (Cr), zirconium (Zr), yttrium (Y), niobium (Nb), or any combination thereof.

4. The catalyst of claim 1, wherein a molar ratio (P/M) of the precious metal (P) to the transition metal (M) of the core is in a range of 1 to 3.

5. The catalyst of claim 1, wherein a molar ratio (P/M) of the precious metal (P) to the transition metal (M) of the shell is in a range of 3 to 10.

6. The catalyst of claim 1, wherein the shell has a thickness in a range of 0.5 nm to 1 nm.

7. The catalyst of claim 1, wherein the core-shell particles have a particle size in a range of 2 nm to 20 nm.

8. The catalyst of claim 1, wherein the hydrophilic group comprises a hydroxyl group, a carbonyl group, a carboxyl group, or any combination thereof.

9. The catalyst of claim 1, wherein a weight ratio (O/H) of oxygen atoms (O) to hydrogen atoms (H) on the surface of the catalyst is in a range of 15 to 35.

10. The catalyst of claim 1, wherein an elution amount of the precious metal or the transition metal, when the catalyst is immersed in a 1 mol/L (M) perchloric acid (HClO₄) solution at a temperature of 80° C. for 24 hours is in a range of 0.1 parts per million (ppm) to 15 ppm per gram of the catalyst.

11. The catalyst of claim 1, further comprising, based on a total weight of the catalyst:
an amount of 30 wt. % to 70 wt. % of the carbon-based support; and
an amount of 30 wt. % to 70 wt. % of the core-shell particles.

12. A method of manufacturing a catalyst for fuel cells, the method comprising:
supporting a precious metal and a transition metal on a carbon-based support;
forming alloyed cores by performing a primary heat treatment on the resultant product;
forming shells by performing a primary surface treatment to the cores with an acid solution;
performing a secondary heat treatment to the catalyst subjected to the a primary surface treatment; and
hydrophilizing a surface of the catalyst by performing a secondary surface treatment to the catalyst subjected to the secondary heat treatment.

13. The method of claim 12, wherein the primarily heat treatment is performed at a temperature of in a range of 700° C. to 1,100° C. for 10 minutes to 4 hours.

14. The method of claim 12, wherein the acid solution comprises nitric acid, sulfuric acid, acetic acid, phosphorous acid, potassium permanganate, hydrogen peroxide, hydrochloric acid, chloric acid, hypochlorous acid, chromic acid, or any combination thereof.

15. The method of claim 12, wherein a concentration of the acid solution is in a range of 0.01 mol/L to 0.5 mol/L.

16. The method of claim 12, wherein the secondary heat treatment is performed at a temperature in a range of 300° C. to 600° C. for 2 hours to 6 hours.

17. The method of claim 12, wherein the secondary surface treatment is performed at a temperature in a range of 70° C. to 100° C. for 10 minutes to 2 hours.

18. The method of claim 12, wherein a molar ratio (P/M) of the precious metal (P) to the transition metal (M) of the cores is in a range of 1 to 3.

19. The method of claim 12, wherein a molar ratio (P/M) of the precious metal (P) to the transition metal (M) of the shells is in a range of 3 to 10.

20. The method of claim 12, wherein a weight ratio (O/H) of oxygen atoms (O) to hydrogen atoms (H) on a surface of the catalyst is in a range of 15 to 35.
